(19) United States
(12) Patent Application Publication
(10) Pub. No.: US 2026/0112837 A1
(43) Pub. Date: Apr. 23, 2026

(54) RELAY MODULE FOR VEHICLE

(71) Applicant: TOYOTA JIDOSHA KABUSHIKI KAISHA, Toyota-shi (JP)

(72) Inventor: Yohei HABARA, Toyota-shi (JP)

(73) Assignee: TOYOTA JIDOSHA KABUSHIKI KAISHA, Toyota-shi (JP)

(21) Appl. No.: 19/357,372

(22) Filed: Oct. 14, 2025

(30) Foreign Application Priority Data
Oct. 17, 2024 (JP) 2024-181916

(51) Int. Cl. H01R 13/24

(52) U.S. Cl. CPC H01R 13/2492; H01R 13/2421; H01R 2201/26

(57) ABSTRACT

A relay module for a vehicle configured to prevent rattling of a movable member being pushed onto a standby position by a return spring. The relay module comprises a movable member having a conductor, and electrode relays brought into an electrically conductive state when the conductor comes into contact therewith. A bore is formed on a case, and the movable member is engaged with the bore by pushing the movable member by a spring. The bore includes a contact surface with which and the movable member is brought into contact.

### CROSS-REFERENCE TO RELATED APPLICATIONS

The present disclosure claims the benefit of Japanese Patent Application No. 2024-181916 filed on Oct. 17, 2024 with the Japanese Patent Office, the disclosures of which are incorporated herein by reference in its entirety.

### BACKGROUND

### Field of the Disclosure

The embodiment of the present disclosure relates to the art of a relay module for a vehicle that switches a terminal between an electrically conductive state and an electrically non-conductive state.

### Discussion of the Related Art

JP-A-2014-7137 describes a relay module for vehicle battery system. The relay module taught by JP-A-2014-7137 comprises a movable unit that is moved in the axial direction by a magnetic field generated by a coil and a spring force of a return spring, a contact core made of a conductor arranged at one end of the movable unit, and a relay electrode opposed to the contact core. According to the teachings of JP-A-2014-7137, the movable member is moved in one of axial directions by energizing the coil so that the contact core comes into contact with the relay electrodes to bring each of the relay electrodes into an electrically conductive state. By contrast, the movable unit is moved in the opposite direction by cutting off the power supply to the coil so that the contact core is isolated away from the relay electrodes to bring the relay electrodes into an electrically non-conductive state.

In the relay module described in JP-A-2014-7137 in which the movable unit reciprocates in the axial direction, a clearance is maintained between the movable unit and a guide section for guiding the movable unit. Therefore, in a situation where the movable unit being pushed onto the case by the return spring is vibrated, the movable unit moves within the clearance between the movable unit and the guide section, and consequently the movable unit and the case are damaged by friction.

### SUMMARY

Aspects of embodiments of the present disclosure have been conceived noting the foregoing technical problems, and it is therefore an object of the present disclosure to provide a relay module for a vehicle configured to prevent rattling of a movable member being pushed onto a standby position by a return spring.

According to the exemplary embodiment the present disclosure, there is provided a relay module for a vehicle, comprising: a movable member having a conductor; electrode relays that are brought into an electrically conductive state by moving the movable member thereby bringing the conductor into contact with the electrode relays; an elastic member that pushes the movable member in a predetermined direction; a case that houses the movable member; and a bore that is formed on any one of the movable member and the case. In order to achieve the above-explained objective, according to the exemplary embodiment of the present disclosure, the other one of the movable member and the case is engaged with the bore by pushing the movable member by the elastic member. Specifically, the bore includes a contact surface that is inclined with respect to a travelling direction of the movable member, and the other one of the movable member and the case is brought into contact with the contact surface of the bore.

In a non-limiting embodiment, the bore may be formed in the case, and the contact surface may include a tapered surface in which an inner diameter thereof decreases gradually in a direction to push the movable member by the elastic member.

In a non-limiting embodiment, the movable member may include an engagement section that is brought into engagement with the bore, and the engagement section may include a conical surface or a tapered surface that is tapered in a direction to push the movable member by the elastic member.

In a non-limiting embodiment, the engagement section may include a protrusion formed on an outer circumferential surface of the engagement section to be brought into contact with the contact surface of the bore.

In a non-limiting embodiment, at least three projections may be formed on the outer circumferential surface of the engagement section at predetermined intervals in the circumferential direction.

In a non-limiting embodiment, the engagement section may include a hemispherical surface that is tapered in a direction to push the movable member by the elastic member.

In a non-limiting embodiment, the electrode relays may include: a terminal connected with an electric storage device of the vehicle, and a terminal connected with a charging circuit to which an electric power is supplied from an external power source.

Thus, according to the exemplary embodiment of the present disclosure, the electrode relays are brought into the electrically conductive state by moving the movable member thereby bringing the conductor into contact with the electrode relays. In the relay module, the bore is formed on any one of the movable member and the case, and the other one of the movable member and the case is engaged with the bore by pushing the movable member by the elastic member. Specifically, the bore includes the contact surface that is inclined with respect to a travelling direction of the movable member, and the other one of the movable member and the case is brought into contact with the contact surface of the bore. Therefore, in the situation where the movable member is pushed onto the bore by the elastic member, a radial load is applied to the movable member from the contact surface according to a pushing load of the elastic member and a taper angle of the contact surface. In other words, a load is applied to the movable member from the contact surface in a direction perpendicular to the travelling direction of the member. Therefore, even if the relay module is vibrated, rattling of the movable member in the case may be reduced. For this reason, wear of the movable member and the case may be reduced.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a diagram schematically showing one example of an electric circuit of a vehicle to which a relay module according to the exemplary embodiment of present disclosure is applied;

FIG. 2 is a cross-sectional view showing a cross-section of the relay module according to the exemplary embodiment of present disclosure;

FIG. 3 is a perspective view showing an example of a movable iron core in which a truncated conical section is formed on its leading end section;

FIG. 4 is a perspective view showing an example of the movable iron core in which the movable iron core is formed into quadrangular prism shape;

FIG. 5 a perspective view showing an example of the movable iron core in which a truncated domed section is formed on its leading end; and

FIG. 6 is a perspective view showing an example of the movable iron core in which a plurality of protrusions are formed on an outer circumferential surface in the leading end section.

### DETAILED DESCRIPTION OF THE PREFERRED EMBODIMENT(S)

An embodiment of the present disclosure will now be explained with reference to the accompanying drawings. Note that the embodiments shown below are merely examples of the present disclosure, and do not limit the present disclosure.

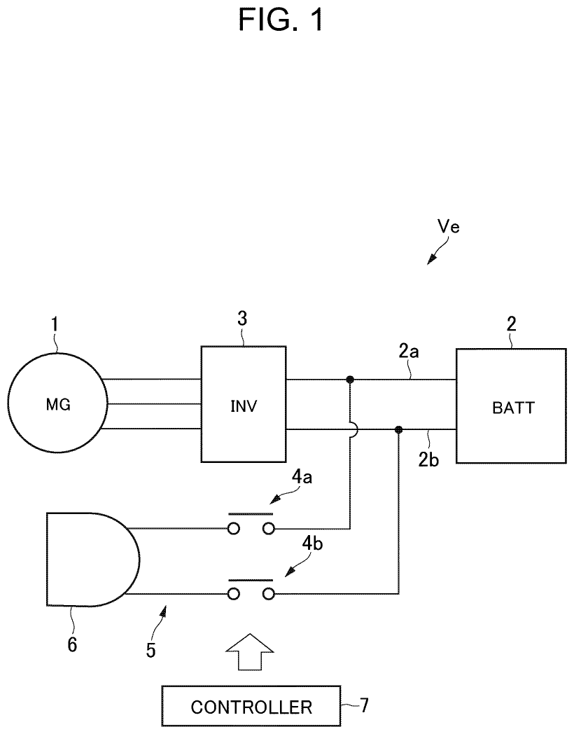

Referring now to FIG. 1, there is shown one example of an electric circuit of a vehicle provided with a relay module according to the exemplary embodiment of present disclosure. The vehicle Ve shown in FIG. 1 comprises a motor (referred to as MG in FIG. 1) 1 serving as a prime mover. As motors of conventional electric vehicles or hybrid vehicles, the motor 1 serves as a motor when an electric power is supplied thereto to generate a driving torque, and serves as a generator when a rotor shaft thereof is rotated passively to translate a kinetic power rotating the rotor shaft into an electric power at least partially. For example, an AC motor such as a synchronous motor or an induction motor may be adopted as the motor 1.

In the vehicle Ve, the electric power is supplied from an electric storage device (referred to as BATT in FIG. 1) 2 to the motor 1, and the electric power generated by the motor 1 is accumulated in the electric storage device 2. As the electric storage device 2, batteries used widely in the conventional electric vehicles or hybrid vehicles may be employed. For example, a secondary battery such as a lithium-ion battery or a nickel hydrogen battery, an electric double layer capacitor or the like may be adopted as the electric storage device 2. That is, the electric storage device 2 is a DC power supply unit. Instead, a battery pack in which a plurality of battery cells are arranged in series may also be adopted as the electric storage device 2.

As described above, in the example shown in FIG. 1, the AC motor is adopted as the motor 1, and a DC power supply unit is adopted as the electric storage device 2. Therefore, an inverter (referred to as INV in FIG. 1) 3 for converting the electric power between the DC power and the AC power is arranged between the motor 1 and the electric storage device 2. The inverter 3 includes a plurality of transistors (not shown), and by controlling the transistors, the DC power supplied from the electric storage device 2 is converted into the three-phase AC power, and the AC power generated by the motor 1 is converted into the DC power to charge the electric storage device 2.

The electric storage device 2 may also be charged by electric power supplied from an external power source. To this end, a charging circuit 5 is connected with the electric storage device 2 through a positive line 2a and a negative line 2b of the electric storage device 2, and relay modules 4a and 4b are disposed on the positive line 2a and the negative line 2b, respectively. A structure of the relay module 4a disposed on the positive line 2a and a structure of the relay module 4b disposed on the negative line 2b are identical to each other. In the following explanations, therefore, these relay modules 4a and 4b will be commonly referred to as the relay module 4.

The charging circuit 5 is provided with a connector 6, and the relay module 4 is brought into an electrically conductive state by connecting an external power source (not shown) with the connector 6. In the example shown in FIG. 1, a DC current regulated to a charging voltage is supplied from the external power source to the charging circuit 5. However, the charging circuit 5 may be provided with a converter for boosting or lowering a voltage supplied from the external power source, and an inverter for converting an AC voltage supplied from the external power source into a DC voltage. In addition, the charging circuit 5 may be further provided with a smoothing capacitor for suppressing fluctuations of the voltage applied to the charging circuit 5.

In order to control the relay module 4, the vehicle Ve is provided with an electronic control unit (hereinafter referred to as the controller) 7. The controller 7 comprises a microcomputer configured to switch a state of the relay module 4 between an electrically conductive state (i.e., a connected state) and an electrically non-conductive state (i.e., an open state), based on incident signals and arithmetic expressions stored in advance. For this purpose, the signals are transmitted to the controller 7 from e.g., a sensor detecting a connection of the external power source with the connector 6, and a sensor detecting a state of charge level (or remaining voltage) of the electric storage device 2. Specifically, the controller 7 is configured to bring the relay module 4 into the electrically conductive state when the external power source is connected with the connector 6, and to bring the relay module 4 into the electrically non-conductive state when the state of charge level of the electric storage device 2 raises to a predetermined level or higher.

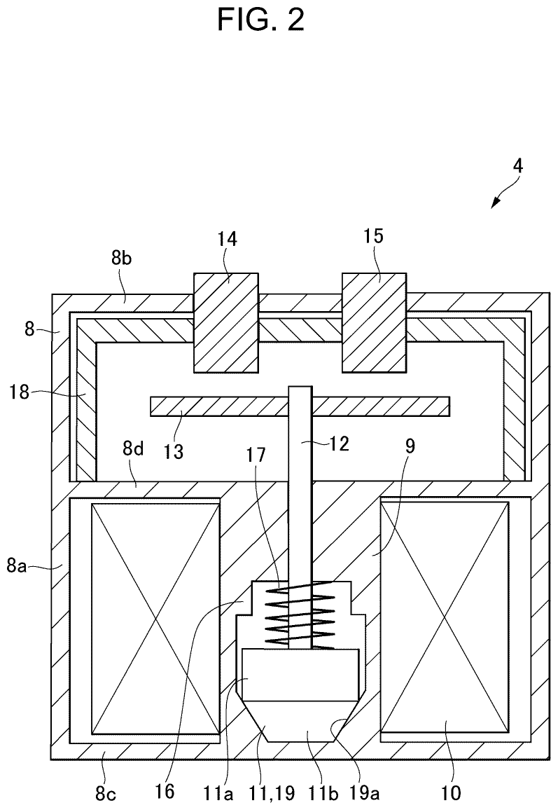

FIG. 2 shows a cross-section of the relay module 4 according to the exemplary embodiment of the present disclosure. As illustrated in FIG. 2, the relay module 4 comprises a cylindrical case 8. Specifically, the case 8 includes a cylindrical sidewall 8a, an upper wall 8b that closes an upper opening of the sidewall 8a, a lower wall 8c that closes a lower opening of the sidewall 8a, and a partition wall 8d that expands horizontally at an axially intermediate portion of the sidewall 8a to divide an internal space of the case 8 into an upper space and a lower space.

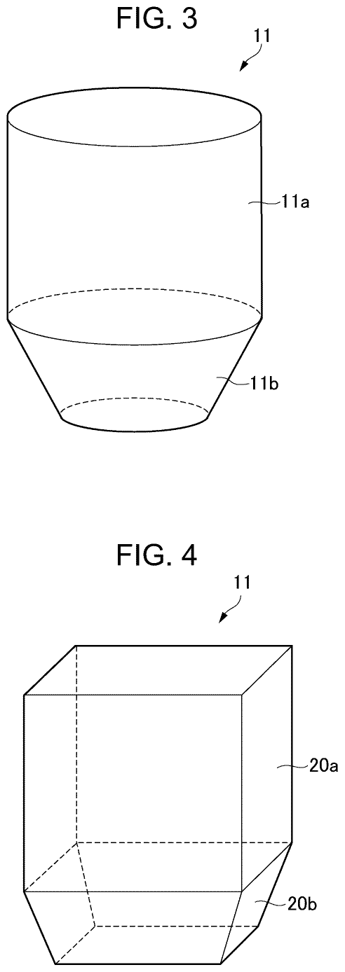

A cylinder 9 is formed between the central portion of the partition wall 8d and the central portion of the lower wall 8c. The cylinder 9 has a holding space in which the movable iron core 11 is accommodated, and a coil 10 is wound around the cylinder 9 in an annular space between the cylinder 9 and the sidewall 8a. In the relay module 4, an electromagnetic force is generated by energizing the coil 10, and the movable iron core 11 is moved upwardly by the electromagnetic force. As shown in FIG. 3, the movable iron core 11 comprises a cylindrical section 11a and an inverse truncated conical section 11b as an engagement section tapered downwardly from the cylindrical section 11a.

A rod 12 whose outer diameter is smaller than an outer diameter of the cylindrical section 11a of the movable iron core 11 is joined to the movable iron core 11. Specifically, the rod 12 penetrates through the partition wall 8d to enter the space above the partition wall 8d, and a disk-shaped movable contact 13 as a conductor is attached to a leading end of the rod 12. That is, the movable contact 13 is moved toward the upper side in FIG. 2 together with the movable iron core 11 by energizing the coil 10. Specifically, the movable contact 13 is formed of a metal material having high electrical conductivity, and is configured to electrically connect an input terminal 14 with an output terminal 15.

A guide space in which the rod 12 reciprocates is formed above the holding space of the cylinder 9, and an inner diameter of the guide space is slightly larger than the outer diameter of the rod 12. That is, an inner circumferential surface of the guide space serves as a guide wall for guiding the rod 12. In addition, a cylindrical stopper 16 protrudes downwardly from an upper end of the holding space of the cylinder 9. Specifically, an inner diameter of the upper end section of the holding space is reduced smaller than the outer diameter of the cylindrical section 11a of the movable iron core 11 to serve as the stopper 16. Therefore, when the movable iron core 11 is moved upwardly, an outer circumferential portion of an upper surface of the movable iron core 11 comes into contact with a lower surface of the stopper 16 thereby preventing the movable iron core 11 from moving upwardly any further.

A return spring 17 as an elastic member of the exemplary embodiment of the present disclosure is fitted onto a lower end portion of the rod 12 accommodated in the holding space of the cylinder 9 while being compressed between the partition wall 8d and the movable iron core 11. Therefore, the movable iron core 11 moved upwardly by energizing the coil 10 is pushed back toward the bottom of the holding space by a spring force of the return spring 17 when the coil 10 is de-energized.

An input terminal 14 and an output terminal 15 serving as electrode relays of the exemplary embodiment of the present disclosure are arranged side by side on the upper wall 8b of the case 8. Specifically, the input terminal 14 is connected with the charging circuit 5 and the output terminal 15 is connected with the electric storage device 2, and the lower end portions of the input terminal 14 and the output terminal 15 protrude toward the upper inner space of the case 8. That is, the input terminal 14 and the output terminal 15 are arranged such that lower ends thereof are opposed to the movable contact 13.

When the coil 10 is energized, the movable iron core 11 is moved upwardly so that the movable contact 13 is brought into contact with the input terminal 14 and the output terminal 15. Consequently, the input terminal 14 and the output terminal 15 are brought into the electrically conductive state through the movable contact 13. By contrast, when the energization of the coil 10 is interrupted, the movable iron core 11 is pushed down by the spring force of the return spring 17 so that the movable contact 13 is isolated from the input terminal 14 and the output terminal 15. Consequently, the input terminal 14 and the output terminal 15 are brought into the electrically non-conductive state.

In addition, in the upper inner space of the case 8 above the partition wall 8d, a permanent magnet 18 is arranged along the sidewall 8a and the upper wall 8b. Therefore, the movable contact 13 is attracted upwardly by the magnetic flux created by the permanent magnet 18 above the movable contact 13. For this reason, a required current value to energize the coil 10 to maintain the contact between the movable contact 13 and the input terminal 14 and the output terminal 15 may be reduced.

In order to improve corrosion resistance, the movable iron core 11, the movable contact 13, the input terminal 14, the output terminal 15, etc. are plated.

As described, in order to allow the movable iron core 11 to reciprocate along the center axis of the cylinder 9 within the holding space of the cylinder 9, the inner diameter of the holding space of the cylinder 9 is slightly larger than the outer diameter of the movable iron core 11. That is, there is a clearance between the outer surface of the movable iron core 11 and the inner surface of the cylinder 9. When the power supply to the coil 10 is interrupted to bring the input terminal 14 and the output terminal 15 into the electrically non-conductive state, the movable iron core 11 is pushed down by the return spring 17 to be brought into contact with the bottom surface of the holding space of the cylinder 9 (i.e., the upper surface of the lower wall 8c of the case 8). In this situation, the movable iron core 11 is displaced within the holding space of the cylinder 9 due to inertia derived from vibrations of the relay module 4 resulting from the propulsion of the vehicle Ve.

Therefore, an inverse truncated conical bore 19 is formed in the lower end section of the holding space of the cylinder 9, and the inverse truncated conical section 11b of the movable iron core 11 being pushed downwardly by the return spring 17 is engaged with the inverse truncated conical bore 19. Specifically, an inner diameter of the inverse truncated conical bore 19 decreases gradually downwardly toward a bottom of the inverse truncated conical bore 19, and a taper angle of a conical (i.e., tapered) inner surface 19a of the inverse truncated conical bore 19 is identical to a taper angle of a conical (i.e., tapered) outer surface of the inverse truncated conical section 11b of the movable iron core 11. Therefore, the conical outer surface of the inverse truncated conical section 11b of the movable iron core 11 being pushed downwardly by the return spring 17 comes into surface contact with the conical inner surface 19a of the inverse truncated conical bore 19. Thus, the conical inner surface 19a serves as a contact surface of the exemplary embodiment of the present disclosure.

In the situation where the conical outer surface of the movable iron core 11 being pushed downwardly by the return spring 17 is in surface contact with the conical inner surface 19a of the inverse truncated conical bore 19, a radial load is applied to the movable iron core 11 from the conical inner surface 19a according to the pushing force of the return spring 17 and the taper angle of the conical inner surface 19a. In other words, a load is applied to the movable iron core 11 from the conical inner surface 19a in a direction perpendicular to the travelling direction of the movable iron core 11. Therefore, even if the vibrations of the vehicle Ve propagate to the relay module 4, the conical outer surface of the movable iron core 11 is tightly held onto the conical inner surface 19a of the inverse truncated conical bore 19, therefore, rattling of the movable iron core 11 in the inverse truncated conical bore 19 may be reduced. In the relay module 4 that selectively connects the external power source with the electric storage device 2, the contact between the movable iron core 11 and the case 8 is always maintained during propulsion of the vehicle Ve. Therefore, the load counteracting the inertial force of the movable iron core 11 is applied to the movable iron core 11 from the cylinder 9 thereby preventing a displacement of the movable iron core 11 in the radial direction. That is, the movable iron core 11 is prevented from sliding on the inner surface of the cylinder 9. Therefore, wear of the movable iron core 11 and the case 8 may be reduced, and peeling of the plating of the movable iron core 11 may be prevented.

Although a component of the axial load is applied to the movable iron core 11 from the conical inner surface 19a of the inverse truncated conical bore 19, the movable iron core 11 is pushed downward by the spring force of the return spring 17 counteracting the axial load. Therefore, a displacement of the movable iron core 11 in the axial direction may be prevented.

In addition, when the coil 10 is energized to move the movable iron core 11 upwardly, the movable iron core 11 may be isolated immediately from the inverse truncated conical bore 19. Therefore, a sliding resistance of the movable iron core 11 may be reduced thereby preventing an increase in power consumption for activating the relay module 4 may be prevented.

Note that the shape of the movable iron core 11 may be altered arbitrarily. For example, as illustrated in FIG. 4, the lower end section of the movable iron core 11 may be shaped into an inverse truncated quadrangular pyramid. Specifically, the movable iron core 11 shown in FIG. 4 comprises a quadrangular prism section 20a and an inverse truncated quadrangular pyramid section 20b as an engagement section having four inclined surfaces extending individually from the respective side walls of the quadrangular prism section 20a. In this case, the lower end section of the holding space of the cylinder 9 is shaped into an inverse truncated quadrangular pyramid bore 19, and the inclined surfaces of the inverse truncated quadrangular pyramid section 20b come into contact with inclined contact surfaces of the inverse truncated quadrangular pyramid bore 19.

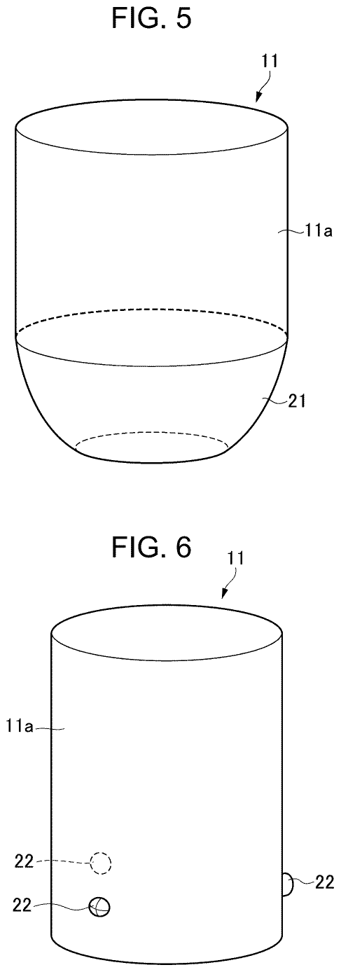

As illustrated in FIG. 5, the engagement section of the movable iron core 11 may also be shaped into an inverse truncated domed section 21. In this case, the lower end section of the holding space of the cylinder 9 is shaped into an inverse truncated domed bore 19, and a truncated hemispherical surface of the inverse truncated domed section 21 comes into contact with a truncated hemispherical contact surface of the inverse truncated domed bore 19. In addition, as illustrated in FIG. 6, the inverse truncated conical section 11b may be omitted from the movable iron core 11, and instead, at least three hemispherical protrusions 22 may be formed on the movable iron core 11 at predetermined intervals in the circumferential direction. In this case, the lower end section as the engagement section of the holding space of the cylinder 9 is shaped into a cylindrical bore 19, and the hemispherical protrusions 22 come into contact with an inner circumferential contact surface of the cylindrical bore 19.

Further, in order to restrict the horizontal movement of the movable iron core 11 in the cylinder 9, a conical recess may also be formed on the lower end surface of the movable iron core 11. In this case, a conical protrusion is formed on the bottom surface of the cylinder 9, and the conical protrusion is inserted into the conical recess formed on the lower end surface of the movable iron core 11.

Furthermore, the relay module according to the exemplary embodiment of the present disclosure may include a movable member that is pushed onto a predetermined site by the return spring during propulsion of the vehicle Ve, and the input terminal and the output terminal may also be brought into the electrically conductive state by pushing the movable member by the return spring.

What is claimed is:

1. A relay module for a vehicle, comprising:
a movable member having a conductor;
electrode relays that are brought into an electrically conductive state by moving the movable member thereby bringing the conductor into contact with the electrode relays;
an elastic member that pushes the movable member in a predetermined direction;
a case that houses the movable member; and
a bore that is formed on any one of the movable member and the case,
wherein the other one of the movable member and the case is engaged with the bore by pushing the movable member by the elastic member,
the bore includes a contact surface that is inclined with respect to a travelling direction of the movable member, and
the other one of the movable member and the case is brought into contact with the contact surface of the bore.

2. The relay module for the vehicle as claimed in claim 1,
wherein the bore is formed in the case, and
the contact surface includes a tapered surface in which an inner diameter thereof decreases gradually in a direction to push the movable member by the elastic member.

3. The relay module for the vehicle as claimed in claim 1,
wherein the bore is formed in the case,
the movable member includes an engagement section that is brought into engagement with the bore, and
the engagement section includes a conical surface or a tapered surface that is tapered in a direction to push the movable member by the elastic member.

4. The relay module for the vehicle as claimed in claim 1,
wherein the bore is formed in the case,
the movable member includes an engagement section that is brought into engagement with the bore, and
the engagement section includes a protrusion formed on an outer circumferential surface of the engagement section to be brought into contact with the contact surface of the bore.

5. The relay module for the vehicle as claimed in claim 4, wherein at least three projections are formed on the outer circumferential surface of the engagement section at predetermined intervals in the circumferential direction.

6. The relay module for the vehicle as claimed in claim 1,
wherein the bore is formed in the case,
the movable member includes an engagement section that is brought into engagement with the bore, and
the engagement section includes a hemispherical surface that is tapered in a direction to push the movable member by the elastic member.

7. The relay module for the vehicle as claimed in claim 1, wherein the electrode relays include:
a terminal connected with an electric storage device of the vehicle, and
a terminal connected with a charging circuit to which an electric power is supplied from an external power source.
